(19) United States
(12) Patent Application Publication
(10) Pub. No.: US 2013/0099935 A1
(43) Pub. Date: Apr. 25, 2013

(54) Light Based Communication Port For Use On Downhole Tools

(71) Applicants: Sebastine Ujereh, Houston, TX (US); Jonathan Yeboah, Sugar Land, TX (US); Emil Steve Macha, Sugar Land, TX (US); Laurent Villegas, Houston, TX (US); Christopher S. Del Campo, Houston, TX (US)

(72) Inventors: Sebastine Ujereh, Houston, TX (US); Jonathan Yeboah, Sugar Land, TX (US); Emil Steve Macha, Sugar Land, TX (US); Laurent Villegas, Houston, TX (US); Christopher S. Del Campo, Houston, TX (US)

(73) Assignee: Schlimberger Technology Corporation

(21) Appl. No.: 13/505,146

(22) PCT Filed: Jun. 3, 2010
(86) PCT No.: PCT/US10/37232

§ 371 Date: Aug. 22, 2012

Related U.S. Application Data
(60) Provisional application No. 61/258,660, filed on Nov. 6, 2009.

(51) Int. Cl. G01V 8/20

(52) U.S. Cl. CPC G01V 8/20
USPC 340/854.7

(57) ABSTRACT

A wellbore measurement instrument includes a housing configured to move along an interior of a wellbore. At least one sensor configured to measure a wellbore parameter is disposed in the housing. A controller disposed in the housing. The controller including at least one of a data storage device and a device to control operation of the at least one sensor. A first optical communications port is disposed in a first aperture in the housing. The first optical communications port includes an electrically operated light source. The first aperture in the housing is sealingly closed by a port plug having an optically transparent window therein. The port plug is configured to resist entry of wellbore fluid into an interior of the housing.

### CROSS-REFERENCE TO RELATED APPLICATIONS

Priority is claimed from U.S. Provisional Application No. 61/258,660 filed on Nov. 6, 2009.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of instruments moved through wellbores drilled through subsurface rock formations, wherein such instruments measure one or more parameters related to the wellbore, the conveyance mechanism and/or the rock formations. More specifically, the invention relates to communication connectors associated with such instruments to enable communication of instrument operating status and/or data stored in the instrument and/or communication of control or operating instructions to such instruments when the instrument is at the Earth's surface.

2. Background Art

Many types of wellbore measurement instruments are known in the art. Such instruments generally include an elongated, pressure resistant housing configured to move through a wellbore drilled through subsurface rock formations. The housing generally includes one or more sensors that measure selected parameters in the wellbore. The parameters, without limitation, include those related to the physical properties of the wellbore itself (e.g., temperature, pressure, fluid content, wellbore geodetic trajectory); construction of the wellbore (e.g., torque and/or axial force applied to a drill bit) and the formations surrounding the wellbore (e.g., resistivity, acoustic velocity, neutron interactive properties, density, and pore fluid pressure and composition).

The housing may be configured to be moved through the wellbore using several different techniques known in the art, including, without limitation, within a drill string or other jointed pipe string, on coiled tubing, or on armored electrical cable or slickline.

Irrespective of the conveyance device used, and irrespective of the types of sensor(s) used in any particular wellbore measurement instrument, such instruments typically include some form of data storage device therein and/or a controller that may be reprogrammed so that measurement and/or data storage and communication functions of the instrument may be changed to suit a particular purpose. Access to the data storage and/or access to the instrument controller typically requires electrical connection to a suitable communications port in the instrument, particularly for those instruments designed to be conveyed other than on an armored electrical cable. Communication ports known in the art include electrical connectors that are designed specifically for the particular instrument. More specifically, the arrangement of electrical contacts in the particular connector is typically unique to the type of instrument. Such arrangement of electrical contacts also requires that an electrical cable used to connect the communication port to a surface device (such as a computer or other data processor) must also be specially made to engage the electrical contacts on the communication port connector. Such specialized communication port connectors and corresponding cables can be expensive to manufacture, and may create logistical difficulties in the event of cable failure, e.g., timely obtaining a replacement.

Additionally, the necessity of a cable reduces the ease and speed with which the communication can take place. Finally the communication is impossible without a PC or similar surface device, adding complexity and more cost to the process. A sonic device (buzzer) is another instrument known in the art used to relay information between the measuring instrument and the instrument's human operator. The method used with the buzzer is to communicate with the tool operator through a series of high volume “beeps” of selected timing and duration. This technique is limited due to the difficulty in hearing on an average rig floor which has a number of very high volume sound sources. Not only does external noise interfere, but sound penetration through the typical housing of downhole tools is limited. Lastly, the range of information that can be transferred is minimal when dealing with sound communication in an uncontrolled environment.

What is needed is a more reliable device for communicating certain instrument signals to the instrument operator and/or to a surface device.

### SUMMARY OF THE INVENTION

A wellbore measurement instrument according to one aspect of the invention includes a housing configured to move along an interior of a wellbore. At least one sensor configured to measure a wellbore parameter is disposed in the housing. A controller is also disposed in the housing. The controller includes at least one of a data storage device and a device to control operation of the at least one sensor. A first optical communications port is disposed in a first aperture in the housing. The first optical communications port includes an electrically operated light source. The first aperture in the housing is sealingly closed by a port plug having an optically transparent window therein. The port plug is configured to resist entry of wellbore fluid into an interior of the housing.

A method for making an optical communication device for a wellbore measuring instrument according to another aspect of the invention includes molding an electrically powered light source into a first casing. The first casing is made from a moisture impermeable, electrically insulating material. Contacts on the light source are electrically connected to selected circuits in the instrument. The first casing is inserted into a first port in a wall of a housing of the instrument. The first port is then sealed with a plug having an optically transparent window therein. The window is configured to resist entry of wellbore fluid into an interior of the housing.

Other aspects and advantages of the invention will be apparent from the following description and the appended claims.

### BRIEF DESCRIPTION OF THE DRAWINGS

FIG. 1 shows an example MWD/LWD wellbore measurement instrument system operating in a wellbore.

FIGS. 2A and 2B show a side and back end view, respectively, of an example communication light source or photodetector.

FIG. 3 shows the example light source or photodetector in a port through the housing wall of the measuring instrument.

FIGS. 4A through 4D show various views of a port plug used to close the port in which either the photodetector or the light source is located.

FIG. 5 shows an example communication cable and attachment fixture for the wellbore measurement instrument.

### DETAILED DESCRIPTION

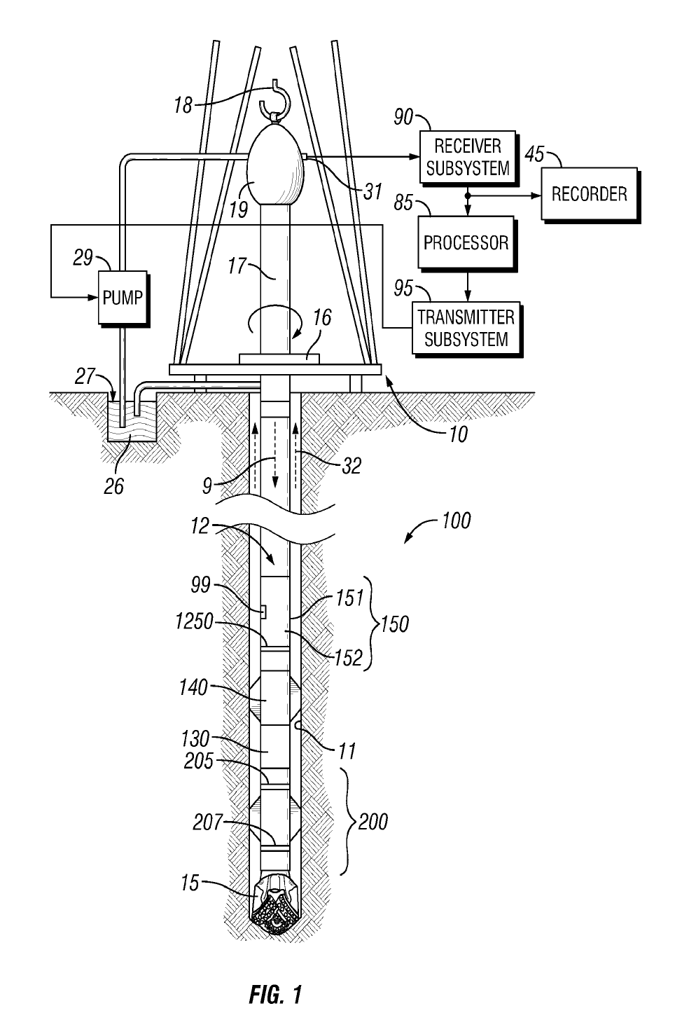

Referring to FIG. 1, there is illustrated an example wellbore measurement instrument that can be used with the invention. The instrument in the present example is in the form of a measuring-while-drilling apparatus. As used herein, “wellbore measurement instrument” is intended to mean any instrument configured to move along the interior of a wellbore and make measurements of at least one parameter related to the wellbore, the formations surrounding the wellbore or the dynamics of a conveyance device used to move the instrument along the wellbore.

The example manner of instrument conveyance shown in FIG. 1 is known as measurement-while-drilling, also called measuring-while-drilling or logging-while-drilling and is intended to include the taking of measurements in a wellbore near the end of a jointed pipe assembly. Such pipe assembly typically includes a drill bit and at least some of the drill string (the jointed pipe assembly) being disposed in the wellbore during drilling, pausing, and/or tripping. It is to be clearly understood that the example shown in FIG. 1 is intended only to serve as an example of wellbore measurement instruments and modes of instrument conveyance that may be used in accordance with the invention. Other modes of instrument conveyance include, without limitation, by any other form of segmented (jointed) pipe, coiled tubing, wireline, slickline, hydraulic pumping and wellbore tractors. Accordingly, the invention is not limited to use with while-drilling instrumentation as shown in FIG. 1.

In the example of FIG. 1, a platform and derrick 10 are positioned over a borehole 11 that is formed in the subsurface rock formations by rotary drilling. A drill string 12 is suspended within the borehole and includes a drill bit 15 at its lower end. The drill string 12 and the drill bit 15 attached thereto are rotated by a rotating table 16 (energized by means not shown) which engages a kelly 17 at the upper end of the drill string. The drill string 12 is suspended from a hook 18 attached to a travelling block (not shown). The kelly 17 is connected to the hook through a rotary swivel 19 which permits rotation of the drill string 12 relative to the hook. Alternatively, the drill string 12 and drill bit 15 may be rotated from the surface by a “top drive” (not shown) type of drilling rig. Drilling fluid or mud 26 is contained in a tank or pit 27. A pump 29 pumps the drilling fluid into the drill string 12 via a port in the swivel 19 to flow downward (arrow 9) through the center of drill string 12. The drilling fluid exits the drill string 12 via courses or nozzles (not shown) in the drill bit 15 and then circulates upward in the annular space between the outside of the drill string 12 and the wall of the wellbore, commonly referred to as the “annulus”, as indicated by the flow arrows 32. The drilling fluid lubricates and cools the bit 15 and carries formation cuttings to the surface. The drilling fluid is returned to the pit 27 for recirculation. An optional directional drilling assembly (not shown) with a mud motor having a bent housing or an offset sub could also be used. It is also known in the art to use a “straight housing” mud driven motor to turn the bit either alone or in combination with rotational energy supplied from the surface (kelly 17 or top drive [not shown]).

Mounted within the drill string 12, preferably near the drill bit 15, is a bottom hole assembly, generally referred to by reference numeral 100, which includes capabilities for measuring, processing, and storing information, and communicating with a recording unit 45 at the earth's surface. As used herein, “near” the drill bit 15 generally means within several drill collar lengths from the drill bit. The bottom hole assembly 100 includes a measuring and local communications apparatus 200 which is described further below. The local communications apparatus may accept as input signals from one or more sensors 205, 207 which may measure any “wellbore parameter” as described above.

In the example of the illustrated bottom hole assembly 100, a drill collar 130 and a stabilizer collar 140 are shown successively above the local communications apparatus 200. The collar 130 may be, for example, a “pony” (shorter than the standard 30 foot length) collar or a collar housing for a measuring apparatus which performs measurement functions. The need for or desirability of a stabilizer collar such as 140 will depend on drilling parameters. Located above stabilizer collar 140 is a surface/local communications subassembly 150. The communications subassembly 150 in the present example may include a toroidal antenna 1250 used for local communication with the local communications apparatus 200, and a known type of acoustic communication system that communicates with a similar system at the earth's surface via signals carried in the drilling fluid or mud. The to-surface communication system in subassembly 150 includes an acoustic transmitter which generates an acoustic signal in the drilling fluid that is typically representative of one or more measured downhole parameters. One suitable type of acoustic transmitter employs a device known as a “mud siren” which includes a slotted stator and a slotted rotor that rotates and repeatedly interrupts the flow of drilling fluid to establish a desired acoustic wave signal in the drilling fluid. Electronics (not shown separately) in the communications subassembly 150 may include a suitable modulator, such as a phase shift keying (PSK) modulator, which conventionally produces driving signals for application to the mud transmitter. These driving signals can be used to apply appropriate modulation to the mud siren. The generated acoustic mud wave travels upward in the fluid through the center of the drill string at the speed of sound in the fluid. The acoustic wave is received at the surface of the earth by transducers represented by reference numeral 31. The transducers, which are, for example, piezoelectric transducers, convert the received acoustic signals to electronic signals. The output of the transducers 31 is coupled to the surface receiving subsystem 90 which is operative to demodulate the transmitted signals, which can then be coupled to processor 85 and the recording unit 45. A surface transmitting subsystem 95 may also be provided, and can control interruption of the operation of pump 29 in a manner which is detectable by transducers (represented at 99) in the communication subassembly 150, so that there can be two way communication between the subassembly 150 and the surface equipment when the wellbore measurement instrument is disposed in the wellbore. In such systems, surface to wellbore communication may be provided, e.g., by cycling the pump(s) 29 on and off in a predetermined pattern, and sensing this condition downhole at the transducers 99. The foregoing or other technique of surface-to-downhole communication can be utilized in conjunction with the features disclosed herein. The communication subsystem 150 may also conventionally include (not show separately for clarity of the illustration) acquisition, control and processor electronics comprising a microprocessor system (with associated memory, clock and timing circuitry, and interface circuitry) capable of storing data from one or more sensors, processing the data and storing the processed data (and/or unprocessed sensor data), and coupling any selected portion of the information it contains to the transmitter control and driving electronics for transmission to the surface. A battery (not shown) may provide electrical power for the communications subassembly 150. As is known in the art, a downhole generator (not shown) such as a so-called “mud turbine” powered by the drilling fluid, can also be used to provide power, for immediate use or battery recharging, during times when the drilling fluid is moving through the drill string 12. It will be understood that alternative acoustic or other techniques can be employed for communication with the surface of the earth. As will be explained in more detail below, communication with the microprocessor system in the communications subassembly 150 when the instrument is at the surface is an element of one embodiment.

The communications subassembly 150 may have a first communications port 151 in the wall of the part of the drill string 12 including the communications subassembly 150 for such purpose to be explained in more detail below. The communications subassembly may also include, in some examples, a second communications port 152 to be used for such purpose as will be more fully explained below.

In other examples of a wellbore measurement instrument that are conveyed other than as part of a drill string (see the examples described above), the instrument housing (e.g., wall of part of the drill string 12) may include a second, similarly configured communications port through the wall thereof.

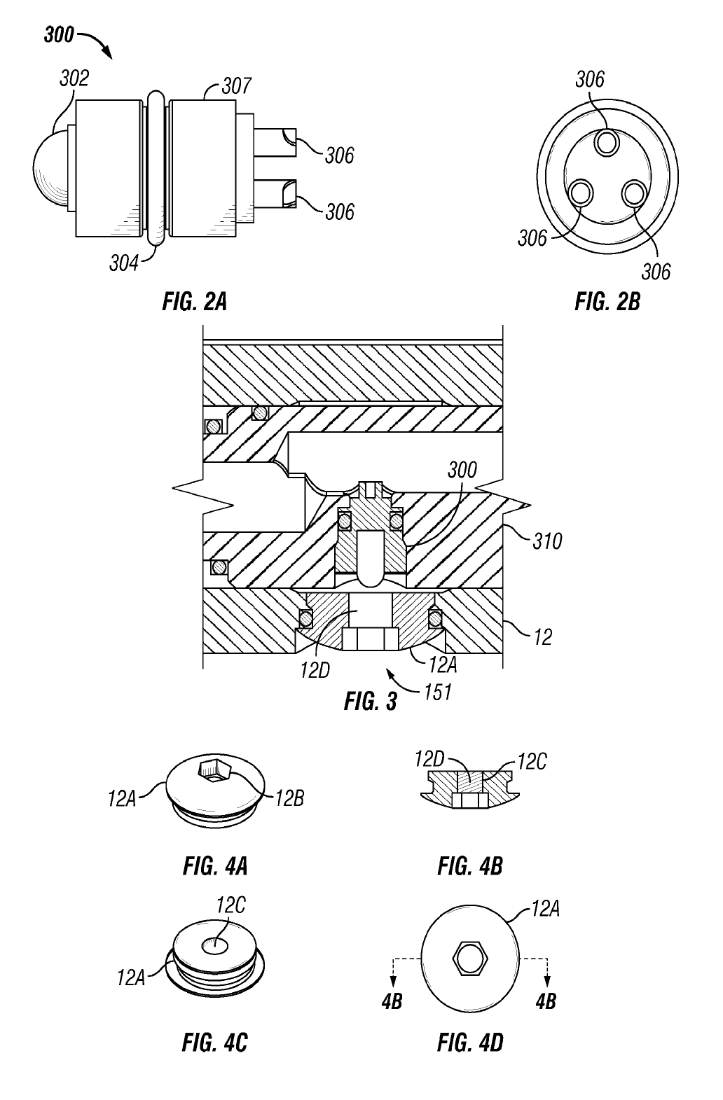

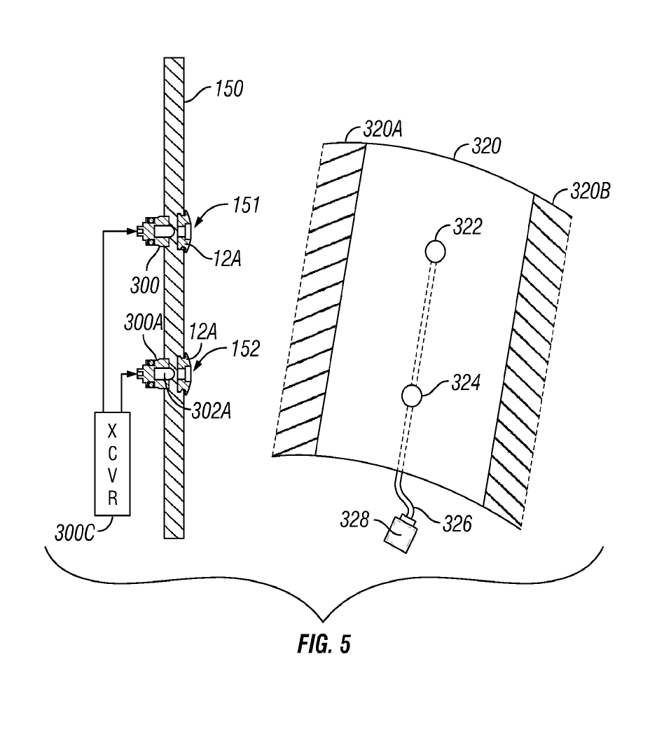

FIGS. 2A and 2B show one example of an optical communication device 300. The device may include an electrically operated light source 302. The electrically operated light source may be, for example, a light emitting diode (LED) or other type of electrically activated source of light. The light source 302 may in some examples emit visible light, such that the instrument operator may observe operation of the light source 302. Visual observation of the light source 302 may enable the operator to determine, for example, instrument operating status, or to observe any data or control signals stored in the instrument susceptible to operator observation and interpretation. The light source 302 may include multiple colors, e.g., red, blue and green, to enable more types of information to be interpretable by the instrument operator. The light source 302 in other examples may emit infrared or other non-visible light to transmit information from the instrument to a surface device, such as the recording unit 45 or a computer as will be further explained below with reference to FIG. 5.

The light source 302 may be molded or otherwise formed into a casing 307. The casing 307 should be made from a material that is electrically non-conductive and is at least impermeable to moisture, and may in some cases be resistant to pressure so as to exclude entry of wellbore fluid into the interior of the instrument in the event of failure of a port plug (FIG. 3). The casing 307 may include provision for an o-ring 304 or similar seal which sealingly engages the wall of the port (151 in FIG. 1). The light source 302 will typically include two or more electrical contacts 306 which may be connected to suitable circuits in the measuring instrument (e.g., in the communication subassembly 150 in FIG. 1). The electrical contacts 306 are shown more clearly in FIG. 2B.

FIG. 3 shows the optical communication 300 device of FIG. 2 disposed in the port 151 in the wall of the instrument. The optical communication device 300 may extend through the port 151 into a circuit chassis 310 of the instrument. The port 151 may be sealingly closed with a port plug 12A. The port plug 12A has an optically transparent window 12D made of material such as boron glass, boron silicate glass or certain types of plastic such that wellbore fluids are excluded from entering the port 151. Various views of the port plug 12A and the optically transparent window 12D are shown in FIGS. 4A through 4D. FIG. 4C in particular shows the window 12D disposed in a suitably shaped opening 12C in the plug 12A. The part of the plug opening 12C external to the window 12D may include a hex or similar configuration (e.g., 12B in FIG. 4A can enable a tool (not shown) to engage the plug 12A for tightening in the port (151 in FIG. 3)).

In another example, wherein a second optical communications port (152 in FIG. 1) is included in the wellbore measuring instrument (e.g., in 150 in FIG. 1), a second optical communication device may be included in such port. The second optical communication device may have substantially the same structure as shown in FIGS. 2A, 2B, 3 and 4A-4D, with the difference being that the light source (302 in FIG. 2A) is substituted by a photodetector (302A in FIG. 5). Having both a light source and a photodetector may enable bidirectional optical communication with the measuring instrument.

An example of the measuring instrument including bidirectional communication capability is shown in FIG. 5. The instrument, e.g., in the communications subsystem 150 may include first 151 and second 152 communication ports as explained above. The first port 151 may include the light source 300 as explained above. The second port 152 may include a photodetector 300A consisting of a photosensitive element 302A disposed in a structure (casing, o-ring, etc.) substantially as explained with reference to the light source in FIGS. 2A, 2B, 3 and 4A-4D. Because the port plugs 12A each include an optically transparent window (12C in FIG. 4C), it is possible to communicate with the instrument without the need to remove the plugs 12A. Such capability may reduce the amount of maintenance required, or may reduce the incidence of seal failure by reducing the number of insertion and removal operations for the port plugs 12A. An example communication coupling is also shown in FIG. 5. The communication coupling 320 may include, for example, optically opaque fabric or plastic which may be wrapped around the instrument housing (e.g., drill collar section 12 in FIG. 1). Locking devices 320A, 320B, may be located at the ends of the fabric or plastic, for example fabric loop and hook fasteners made from material sold under the trademark VELCRO, which is a registered trademark of Velcro Industries, B.V., a Netherlands corporation. Any other device which may secure the communication coupling to the instrument housing may also be used. The communications coupling includes therein a photodetector 322 and an electrically operated light source 324 (e.g., an LED) that are disposed proximate the respective first 151 and second 152 optical communications ports when the communication coupling is affixed to the instrument housing. Electrical connections to the respective photodetector 322 and light source 324 may be made through a suitable cable 326. The cable 326 may be terminated in an industry standard connector 328 for connection to a surface device such as a computer, or may be terminated in a proprietary or other connection for electrical connection to the recording unit (45 in FIG. 1) when the instrument is at the Earth's surface.

Using the communication coupling 320 as shown in FIG. 5 may enable the instrument, through an internal transceiver 300C (which may be a separate device or may be part of the instrument controller described above) to communicate data stored in a data storage device in the instrument and to receive reprogramming instructions or other data from the surface device (e.g., computer or the recording system 45 in FIG. 1). The type of signals optically communicated between the surface device and the instrument is not intended to limit the scope of the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A wellbore measurement instrument, comprising:
a housing configured to move along an interior of a wellbore;
at least one sensor configured to measure a wellbore parameter;
controller disposed in the housing, the controller including at least one of a data storage device and a device to control operation of the at least one sensor; and
a first optical communications port disposed in a first aperture in the housing, the first optical communications port including an electrically operated light source, the first aperture in the housing sealingly closed by a port plug having an optically transparent window therein, the port plug configured to resist entry of wellbore fluid into an interior of the housing.

2. The instrument of claim 1 wherein the electrically operated light source comprises a light emitting diode.

3. The instrument of claim 2 wherein the light emitting diode comprises a multi-color light emitting diode.

4. The instrument of claim 1 wherein the controller is configured to operate the light source to communicate information in the instrument visually to an instrument operator.

5. The instrument of claim 1 further comprising a second optical communications port disposed in a second aperture in the housing, the second optical communications port including a photodetector therein, the second aperture in the housing sealingly closed by a port plug having an optically transparent window therein, the port plug configured to resist entry of wellbore fluid into an interior of the housing.

6. The instrument of claim 5 further comprising an optical communications coupling configured to be removably affixed to an exterior of the instrument housing, the coupling including a photodetector and an electrically operated light source arranged in the coupling to be exposed to the first communication port and the second communication port, respectively, when the coupling is affixed to the instrument housing.

7. The instrument of claim 6 wherein the photodetector and the light source in the communications coupling are electrically connected to a surface device such that signals are transferrable between the instrument and the surface device.

8. A method for making an optical communication device for a wellbore measuring instrument, comprising:
molding an electrically operated light source into a first casing, the first casing made from a moisture impermeable, electrically insulating material;
electrically connecting contacts on the light source to selected circuits in the instrument;
inserting the first casing into a first port in a wall of a housing of the instrument; and
sealing the first port with a plug having an optically transparent window therein, the window configured to resist entry of wellbore fluid into an interior of the housing.

9. The method of claim 8 further comprising molding a photodetector into a second casing;
electrically connecting contacts on the photodetector to selected circuits in the instrument;
disposing the second casing in a second port in the wall of the housing; and
sealing the second port a plug having an optically transparent window therein, the window configured to resist entry of wellbore fluid into the interior of the housing.

10. The method of claim 8 wherein the electrically powered light source comprises a light emitting diode.

11. The method of claim 10 wherein the light emitting diode is a multi-color light emitting diode.

12. The method of claim 8 further comprising causing a controller in the instrument to operate the light source to communicate information stored in the instrument.

13. The method of claim 12 wherein the information is communicated visually to an instrument operator.

14. The method of claim 12 wherein the information is communicated to a photodetector disposed proximate the light source, the photodetector in signal communication with a surface device.

15. The method of claim 9 further comprising disposing an electrically operated light source proximate the second port and communicating signals from a surface device to the instrument by operating the light source disposed proximate the second port.
